(19) United States
(12) Patent Application Publication
(10) Pub. No.: US 2012/0164913 A1
(43) Pub. Date: Jun. 28, 2012

(54) MAGNETIC TOY PIECES

(76) Inventors: Gregory E. Pomeroy, Rockport, MA (US); Paul Karapetian, Somerville, MA (US); Mark Zern, Arlington, MA (US)

(21) Appl. No.: 13/332,197

(22) Filed: Dec. 20, 2011

Related U.S. Application Data
(60) Provisional application No. 61/426,603, filed on Dec. 23, 2010.

(51) Int. Cl. A63H 33/26; B23P 19/00

(52) U.S. Cl. 446/137; 29/428

(57) ABSTRACT

A first toy includes a housing having an elongate shape and a length. The housing includes two surfaces extending along the length that are substantially opposite one another. Two or more chambers are formed within the housing and situated at different positions along the length of the housing. Two or more permanent magnets are each situated within one of the two or more chambers. Each permanent magnet is free to assume a plurality of different orientations. Each permanent magnet is positioned sufficiently close to each one of the two surfaces to enable magnetic interaction with an adjacent permanent magnet contained in a second toy that is contacting the first toy at that one of the two surfaces of the first toy.

### RELATED APPLICATIONS

This application claims priority to, and the benefit of, co-pending U.S. Provisional Application No. 61/426,603, filed Dec. 23, 2010, for all subject matter common to both applications. The disclosure of said provisional application is hereby incorporated by reference in its entirety.

### FIELD OF THE INVENTION

The present invention relates to toy pieces suitable for building a wide variety of constructions, and more particularly to toy pieces containing magnets that enable enhanced permutations of attachment points.

### BACKGROUND OF THE INVENTION

Many toy items are sold that provide consumers with the ability to build a variety of constructions, including various forms of blocks. The ability to configure and stack the blocks, and their resulting stability, depends at least in part upon the particular type of attachment mechanism, if any. Some such toy building blocks utilize attractive forces between magnets to provide attachment between individual blocks. There are benefits to using such magnets as attachments, including that magnets are readily pulled apart, allowing for easy construction and deconstruction.

However, many such building blocks are limited in their range of combination. Using magnetic forces to provide attachment can be somewhat limited since the forces are not as easily controlled or manipulated as other types of existing building block systems.

### SUMMARY

There is a need for a magnetic toy piece having a wider range of construction applications and configurations for combination and stacking. The present invention is directed toward further solutions to address this need, in addition to having other desirable characteristics.

According to a first embodiment of the present invention, a first toy can include a housing having an elongate shape having a length. The housing can include two surfaces extending along the length that substantially oppose one another. Two or more chambers can be formed within the housing and situated at different positions along the length of the housing. Two or more permanent magnets each can be situated within one of the two or more chambers and each can be free to assume a plurality of different orientations (e.g., rotational orientations). Each of the two or more permanent magnets can be positioned sufficiently close to each one of the two surfaces to enable magnetic interaction with an adjacent permanent magnet contained in a second toy that is contacting the first toy at that one of the two surfaces of the first toy.

According to further aspects of the present invention, every permanent magnet contained in the first toy can be sufficiently close to each one of the two surfaces to enable interaction with permanent magnets in a second toy that is contacting the second toy at that one of the two surfaces. The housing can include two additional surfaces extending along the length that substantially oppose each other. Each of the two or more permanent magnets can be positioned sufficiently close to each of the two additional surfaces to enable magnetic interaction with permanent magnets in a second toy that is contacting that one of the two additional surfaces of the first toy. The magnetic interaction can be sufficient to cause each of the two or more permanent magnets in the first toy to assume one of the plurality of different orientations. Each of the two or more permanent magnets can produce a magnetic field that extends beyond each of the two surfaces. The magnetic field that extends beyond each of the two surfaces of each of the two or more permanent magnets can possess a strength sufficient to enable interaction with an adjacent permanent magnet in second toy that is contacting the first toy. For each of the two or more permanent magnets in the first toy, the interaction can be sufficient to cause that one of the two or more permanent magnets to assume one of the plurality of orientations.

According to further aspects of the present invention, each of the two or more permanent magnets can be generally spherical in shape, and each of the two or more chambers can be generally spherical in shape. Each of the two or more permanent magnets can be neodiymium magnet. An additional chamber can be included in the first toy and can be contained within the housing. An additional permanent magnet can be contained within the additional chamber. Each of the two or more chambers can be located at an end of the length of the housing, and the additional chamber can be located at a center of the length of the housing. The housing further can include a block constructed from walnut wood. The housing generally can have a shape of a rectangular prism. The first toy can further include a third hollow chamber formed within the housing and situated at position along the length of the housing. A third permanent magnet can be situated within the third hollow chamber and can be free to assume a plurality of different rotational orientations within the third hollow chamber. The third permanent magnet can be positioned sufficiently close to each one of the two surfaces to enable magnetic interaction with an adjacent permanent magnet contained in a second toy that is contacting the first toy at that one of the two surfaces of the first toy.

According to another embodiment of the present invention, a system can include two or more toys. Each of the two or more toys can include a housing having an elongate shape having a length. The housing can include two surfaces extending along the length that are substantially opposite one another. Two or more hollow chambers can be contained within the housing and situated at different positions along the length of the housing. A permanent magnet can be situated within each of the two or more hollow chambers, such that the permanent magnet is free to rotate in any direction about its center point. The permanent magnet can be situated within each of the two or more hollow chambers and can be positioned sufficiently close to each of the two surfaces such that placing the two or more toy pieces in contact at any combination of the two surfaces of each of the two or more toy pieces produces magnetic interaction.

According to further aspects of the present invention, any permanent magnet in any one of the two or more toys can be sufficiently close to each one of the two surfaces of the any one of the two or more toys to enable interaction with the permanent magnet in at least one of the two or more hollow chambers in the other of the two or more toys when the other of the two or more toys is in contact with the any one of the two or more toys at that one of the two surfaces. For each one of the two or more toys, the housing can include two additional surfaces extending along the length that are substantially opposite each other. The permanent magnet in each of the two or more chambers can be positioned sufficiently close to each of the two additional surfaces to enable magnetic interaction with a permanent magnet in an additional toy that is contacting that one of the two additional surfaces of that one of the two or more toys. For each of the two or more toys, the magnetic interaction can be sufficient to cause the permanent magnet in each of the two or more chambers to assume one of a plurality of different orientations. Each of the two or more toys can include an additional chamber contained within the housing and an additional permanent magnet movably contained in the additional chamber. Each of the two or more chambers can be located at an end of the length and the additional chamber is located at the center of the length.

According to further aspects of the present invention, each of the two or more toys can further include a third hollow chamber formed within the housing and situated at position along the length of the housing. A third permanent magnet can be situated within the third hollow chamber, and the third permanent magnet can be free to assume a plurality of different rotational orientations within the third hollow chamber. The third permanent magnet can be positioned sufficiently close to each one of the two surfaces to enable magnetic interaction with an adjacent permanent magnet contained in an additional toy that is contacting that one of the two surfaces.

According to another embodiment of the present invention, a method of making a first toy can include forming first cavities into a first block or portion of a housing and forming second cavities into a second block or portion of the housing. A permanent magnet can be situated in each of the first cavities formed in the first block or portion of the housing. The second block or portion of the housing can be fastened to the first block or portion of the housing such that the first cavities and the second cavities align to form a first chamber and a second chamber each containing a permanent magnet. The housing thereby can be formed having an elongate shape and a length, and the housing can include two surfaces extending along the length that substantially oppose one another. The permanent magnet situated in each of the first chamber and the second chamber can be positioned sufficiently close to each one of two surfaces to enable magnetic interaction with an adjacent permanent magnet contained in a second toy contacting that one of the two surfaces of the first toy.

According to another embodiment of the present invention, a kit can include a plurality of toys. Each of the plurality of toys can include a housing having an elongate shape having a length. The housing can include at least two surfaces that are substantially parallel one another. Three hollow chambers can be contained within the housing and situated at different positions along the length of the housing. A permanent magnet can be situated within each of the three hollow chambers, such that the permanent magnet in each of the three hollow chambers is free to rotate in any direction relative to its center point and thereby assume any one of a plurality of different rotational orientations. The permanent magnet in each of the three hollow chambers can be situated sufficiently close to each one of the two surfaces to enable magnetic interaction with an additional magnet in an additional toy contacting that one of the two surfaces.

### BRIEF DESCRIPTION OF THE FIGURES

These and other characteristics of the present invention will be more fully understood by reference to the following detailed description in conjunction with the attached drawings, in which:

FIG. 1A is a perspective view of a magnetic toy piece showing various interior components, according to example embodiments of the present invention;

FIG. 1B is a cross sectional side view of the magnetic toy piece of FIG. 1A;

FIG. 2 is a perspective view of the exterior of the magnetic toy piece of FIG. 1A, according to embodiments of the present invention;

FIGS. 3A and 3B are flow charts depicting illustrative methods for making magnetic toy pieces according to aspects of the present invention;

FIG. 4 is a diagrammatic illustration of a magnetic toy piece prior to final assembly according to aspects of the present invention;

FIG. 5 is a diagrammatic illustration of some possible example attachment configurations of the example magnetic toy pieces based at least partially on attractive magnetic forces according to aspects of the present invention;

FIGS. 6A, 6B, and 6C are diagrammatic illustrations of some possible attachment configurations of example magnetic toy pieces based at least partially on both attractive magnetic forces and repulsive magnetic forces, according to aspects of the present invention;

FIG. 7 is a perspective view of an example kit including a plurality of magnetic toy pieces, according to aspects of the present invention;

FIG. 8A is a side view of the kit of FIG. 7, according to aspects of the present invention; and

FIG. 8B is a top view of the kit of FIG. 7, according to aspects of the present invention.

### DETAILED DESCRIPTION

An illustrative embodiment of the present invention relates to a magnetic toy piece and its method of making. The magnetic toy piece can include an elongate block of wood (or other housing component) having a plurality of faces that enclose three internal chambers each housing a permanent magnet. Every surface of the toy piece can be within close proximity of an internal magnet, enabling multiple such pieces to be easily magnetically connected or disconnected at and through any one of the six faces. Each internal magnet is situated near at least four of the six faces of the toy piece, in such a way that each magnet can simultaneously interact with at least one additional toy piece on at least two faces.

Notably, each magnet is permitted to rotate within the internal chamber that houses it, which provides a feature that can be particularly interesting to the builder or user of such toy pieces. Configuring the magnets such that they have at least some degree of rotational freedom within the internal chamber allows the magnets on two toy pieces to align in accordance with typical attractive forces, as would be expected when any two magnets are brought into proximity with one another. Said differently, the alignment of two identical, adjacent magnets on two magnetically connected toy pieces, herein referred to as a “toy dyad,” will typically be such that a positive pole on one of the two magnets is facing a negative pole on the other of the two magnets (assuming other magnetic forces are not at work). Attempting to situate two toy dyads next to each other, however, can provide interesting and potentially unexpected combinations whereby a positive pole faces a positive pole and/or a negative pole faces a negative pole. Depending on the particular rotational orientation and alignment of the poles of the particular magnets, two abutting dyads may experience attractive forces, repulsive forces, or both. This unpredictability and additional connectivity expands the construction possibilities for users of the toy pieces, thereby encouraging creativity and promoting greater entertainment of the user.

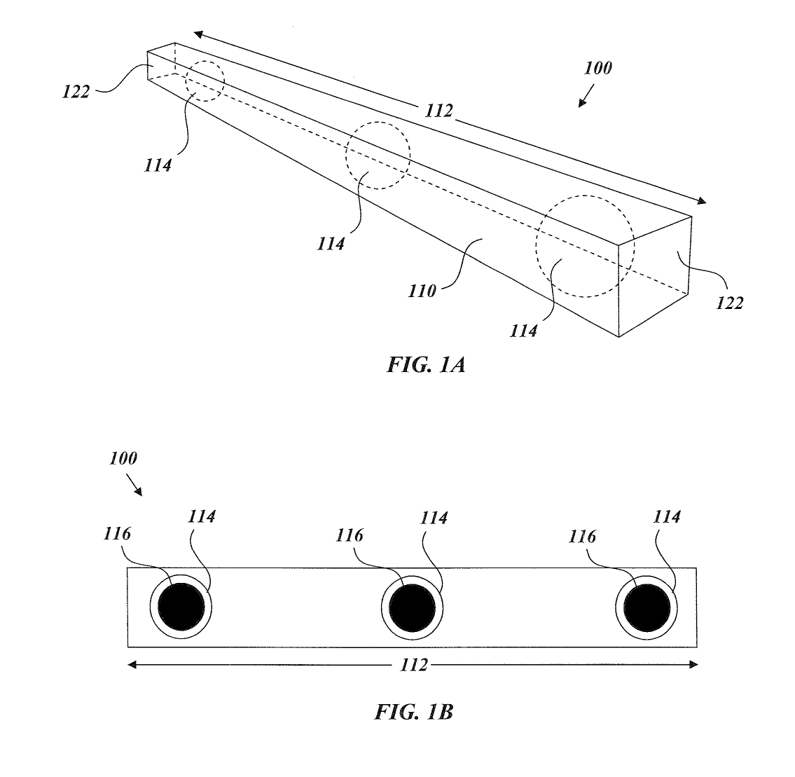

FIGS. 1A through 8C, wherein like parts are designated by like reference numerals throughout, illustrate example embodiments of a magnetic toy piece according to the present invention. Although the present invention will be described with reference to the example embodiments illustrated in the figures, it should be understood that many alternative forms can embody the present invention. One of skill in the art will additionally appreciate different ways to alter the parameters of the embodiments disclosed, such as the size, shape, or type of elements or materials, in a manner still in keeping with the spirit and scope of the present invention.

FIG. 1A depicts a perspective view of a wood block component 110 of an illustrative magnetic toy piece 100. Dotted lines indicate edges that are hidden from view. The wood block component 110 is generally shaped as an elongate rectangular prism having six faces, each of which are generally rectangular shaped. Accordingly, the example wood block component 110 includes three sets of opposing faces or surfaces that are substantially parallel. The wood block component 110 has a length 112 that significantly larger than a width or a height of the wood block component 110. Extending along and through the length 112 are three hollow chambers 114 that are of substantially identical sizes in accordance with one example embodiment of the present invention. A middle chamber 114 is located substantially at the center of the length 112, and each of the two remaining chambers 114 is located toward an end of the length portion 112. Each chamber 114 houses a permanent magnet 116, and the chambers 114 are spherical in the example embodiment of FIG. 1A, e.g., to substantially match a shape of the magnet 116 contained therein. However, other shapes may be possible, such as elongate oval shapes, or other shapes, based at least in part on the desired functionality and interoperability of the magnetic toy piece 100.

FIG. 1B shows a cross-sectional side view of the center of the illustrative magnetic toy piece 100 of FIG. 1A. As depicted, the wood block component 110 forming the housing contains three spherically shaped permanent magnets 116 each contained within one of three chambers 114. Each magnet 116 can be sufficiently sized to enable rotation (e.g., in any direction about a center point thereof), rolling, or other reorientation enabling the magnetic poles of each magnet 116 to face a plurality of different directions while situated within the chamber 114. For example, the magnets 116 can be capable of rotating, pivoting, spinning, or otherwise shifting about or reorienting in response to forces of magnetic attraction or repulsion caused by close proximity to other magnets 116 in separate, abutting toy pieces 100. Thus, the ability of the magnets 116 to move as described can allow variability in the magnetic charge associated with any particular side or surface of the wood block component 110. In particular, the charge associated with a particular face will change depending on the orientation of the magnets 116 contained within the chambers 114. Furthermore, a single face of the magnetic toy piece 100 can have multiple different magnetic charges associated with different positions on the face (e.g., as a result of two magnets 116 in a single magnetic toy piece 100 having different polar orientations).

In some embodiments, the chambers 114 are separated by a sufficient amount of distance such that magnetic forces between magnets 116 of a single magnetic toy piece 100 are not strong enough to impact the orientation of the magnets 116 at any point in time. In other words, the chambers 114 can be spaced in such a way that internal magnetic interactions between magnets 116 have no bearing whatsoever on the orientation of the magnets 116 contained therein. In other embodiments, the chambers 114 within a single toy piece 100 can be spaced close enough such that the magnets 116 contained therein interact magnetically and affect each others' orientations. However, in such embodiments where internal magnetic interaction between the magnets 116 exists, such internal magnetic interaction is weak compared to external magnetic interactions caused by placement of the magnetic toy piece 100 near (e.g., in an abutting manner) an additional magnetic toy piece 100. Accordingly, in all illustrative embodiments, the orientations of the magnets 116 contained within the chambers 114 of a single magnetic toy piece 100 are dominated by external magnetic interactions rather than internal magnetic interactions.

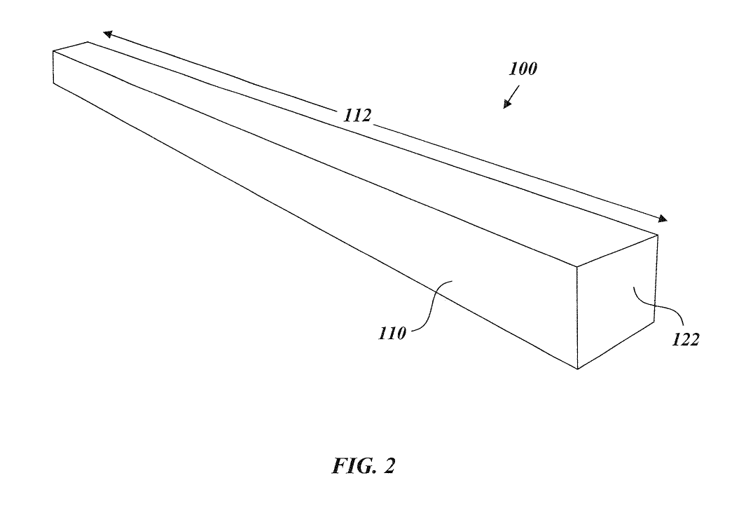

In addition, the magnets 116 can be smaller in size than the chambers 114, in such a way that interesting noises are produced when the magnets 116 are knocked around, shaken, or undergo reorientation of the magnetic poles due to placement next to another magnetic toy piece 100. FIG. 2 illustrates a perspective view of the magnetic toy piece 100 of FIGS. 1A and 1B with no internal components being shown. Accordingly, as illustrated in FIG. 2, the magnets 116 and the three chambers 114 containing the magnets 116 are all hidden from view of the user. Accordingly, to such a user handling the magnetic toy piece 100, noises that are produced are caused by internal components that not visible by external inspection. Thus, the noises produced by hidden internal components (e.g., the magnets 116) can enable the magnetic toy piece 100 to more strongly capture the interest of the user.

One of skill in the art will appreciate that in such a configuration as depicted in the figures and described herein, each magnet 116 has two magnetic poles, which can be indicated as negative (i.e., “north” in conventional magnetism) and positive (i.e., “south” in conventional magnetism). The poles can be located at opposite ends of each sphere in embodiments where the magnets 116 have generally spherical shapes (e.g., similar to the magnetic poles of the Earth). Alternative embodiments, however, implement magnets having alternative shapes and placement of the magnetic poles. Accordingly, the present invention is not limited to the exemplary embodiments depicted in and described with reference to the figures. One of skill in the art will appreciate a range of other suitable shapes of the magnets 116, shapes of the chambers 114, and/or shapes of the wood block component 110 upon reading the present specification. Furthermore, the magnets 116 contained within a single magnetic toy piece 100 can have different shapes and/or sizes from one another, and the chambers 114 contained within a single magnetic toy piece 100 can have different shapes and/or sizes from one another, as would be appreciated by one of skill in the art upon reading the present specification. For example, in some embodiments, the magnet 116 situated at the middle of the length 112 is larger and stronger than the magnets 116 situated nearer the ends of the length 112.

The illustrative embodiment is implemented as a magnetic toy piece primarily intended for children and adults. The illustrative embodiment is not designed for use by infants. As depicted in the figures, the surfaces can be situated at right angles to provide relatively sharp edges for enhancing the user's tactile experience. The wood block component 110 can be made from walnut wood and can possess a total length of about two and nine sixteenths inches (2 9/16″). The depth and height of the wood block component 110 can be about three eighths of an inch (⅜″). The diameter of the chambers 114 can be about nine thirty seconds of an inch ( 9/32″). The middle chamber 114 can be positioned at about the center of the length 112. Each end chamber 114 can be positioned such that its center point is 3/16 inches away from an end surface 122 of the rectangular prism. The magnets 116 can occupy a slightly smaller volume than the chambers 114. In the illustrative embodiment the three magnets 116 each have a diameter of about one quarter of an inch (¼″). The magnets 116 can be neodiymium spherical magnets (grade N42). Other types of magnets, including other types of rare earth magnets, can alternatively or additionally be used. One of skill in the art will appreciate that other dimensions may be utilized in forming the wood block component 110, that are of similar or varying scale to the dimensions provided herein. Embodiments of the present invention are not limited to the specific dimensions disclosed with reference to the illustrative examples. Rather, any suitable dimensions and shapes are contemplated within the scope of the present invention.

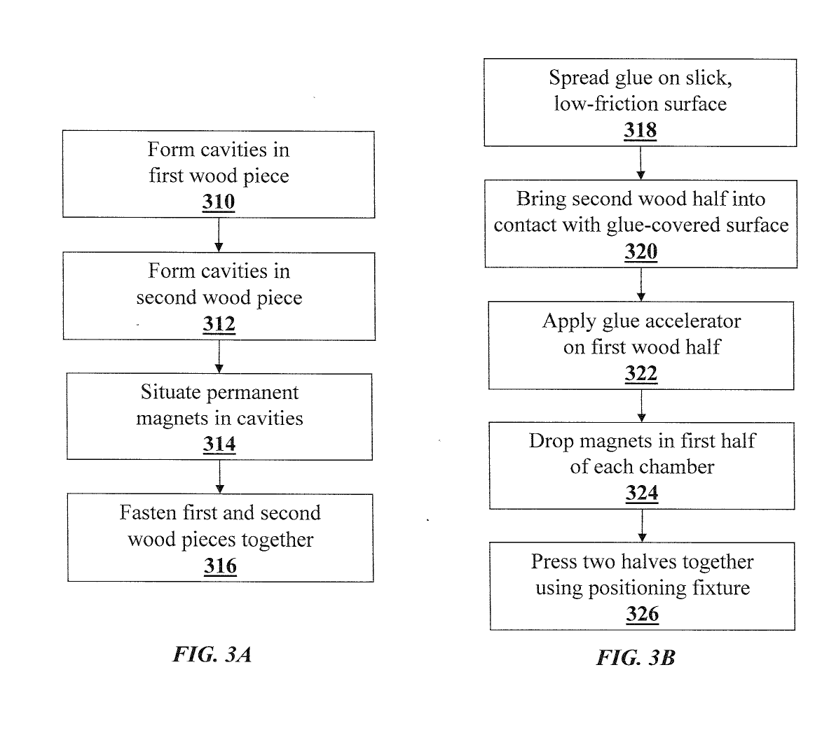

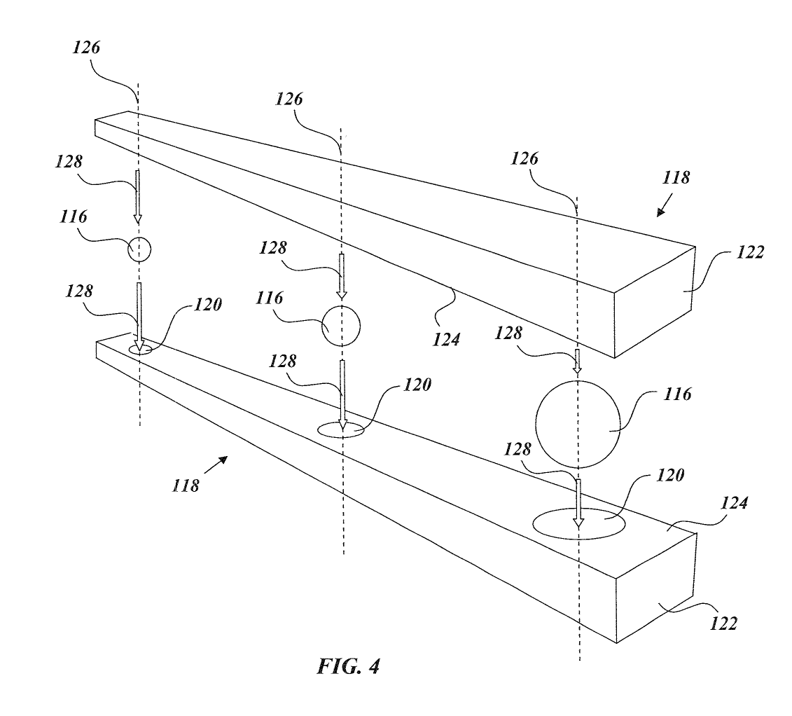

FIG. 3A shows an example method for making illustrative embodiments of the present invention. In particular, the wood block component 110 can be formed from two substantially identical wooden pieces 118 (as depicted in FIG. 4). The term “substantially” is herein used in part to account for the fact that while each piece is intended to be perfectly identical in the example embodiment described herein with reference to FIG. 3A, this is often not the case in large-scale manufacturing and production. Multiple pieces, even made according to a single process and using the same equipment, often exhibit some limited range of random variance. Accordingly, the term “substantially” accounts for such variance. Initially, the two wooden halves can be solid walnut measuring about two and nine sixteenths inches (2 9/16″) in length, three eights of an inch (⅜″) in depth, and three sixteenths of an inch ( 3/16″) in height.

Continuing with FIG. 3A, three half-spherical (or other shaped) cavities 120 (diagrammatically illustrated in FIG. 4) can be formed in one of the wooden pieces 118 (step 310). The cavities 120 can form a first half or portion of what will eventually become the chambers 114. This process similarly can be performed for the second wooden piece 118 to form corresponding (e.g., identical) cavities 120 therein (step 312). Each cavity 120 can be formed in a surface 124 of its respective wooden piece 118 along which the two wooden pieces 118 are to be joined. The steps 310 and 312 can be performed such that when the two wooden pieces 118 are aligned with the sets of cavities 120 facing each another, the cavities 120 line up to form the chambers 114. One example method of forming the cavities 120 is to rout the wood using a wood router, or any other suitable equipment well known to those of skill in the art.

For example, FIG. 4 depicts a perspective view of a first wooden piece 118 and a second wooden piece 118 during assembly into a single toy piece 100, and subsequent to the steps 310 and 312 of forming half-spherical cavities 120 within the length 112 of the wooden pieces 118. The cavities on the upper wooden piece 118 are hidden from view in FIG. 4.

Continuing with FIG. 3A, a permanent magnet 116 of appropriate size and shape is placed within each of the cavities 120 of one of the wooden pieces 118 (step 314). The magnets 116 can have a generally spherical shape, in accordance with certain illustrative embodiments of the present invention described previously herein. In the example embodiment depicted in FIG. 4, upon the magnets 116 being placed in the cavities 120, only slightly more than half of the magnets 116 will be embedded and hidden from view. Once situated appropriately, the second wooden piece 118 can be aligned with and fastened to the first wooden piece (step 316), such that the chambers 120 are properly formed. This is depicted in FIG. 4 by the imaginary axes 126, along which corresponding cavities 120 in the two facing wooden pieces 118 are aligned. The directional arrows 128 in FIG. 4 illustrate a direction along the imaginary axes 126 in which the first and second wooden pieces 118 are to be fastened or otherwise adjoined. The two wooden pieces 118 can be joined together using any suitable fastening mechanism, e.g., which does not interfere with the ability of the magnets 116 to rotate within the chambers 114. Accordingly, depending on the particular choice of fastening mechanism, additional steps may be necessary to ensure that the fastening mechanism is suitably placed in a manner that does not inhibit motion of the magnets 116.

In one example embodiment, the two wooden pieces 118 are fastened together using wood glue. For instance, FIG. 3B demonstrates one illustrative wood gluing method for fastening the two wooden pieces 118. In step 318, prior to situating the magnets 116 in the cavities 120, glue is spread on a slick, low-friction surface (not shown). For example, instant glue (thin or medium) can be utilized, such as TIGHTBOND® wood glue manufactured by Franklin International, headquartered in Columbus, Ohio. Quickly thereafter, the second wooden piece 118 can be placed in contact with the low-friction surface (step 320). In this manner, the surface 124 of the second wooden piece 118 can be brought into contact with the glue situated on the low-friction surface. The second wooden piece 118 is then removed from the slick surface, upon which it has acquired a layer of glue. Glue accelerator is applied via spraying onto the first wooden piece 118 (step 318). Similarly to the application of the glue, the glue accelerator is applied along the surface 124 of the first wooden piece 118. Applying the accelerator can allow for faster curing once the two wooden pieces 118 are joined. Next, the magnets 116 are placed in the cavities 120 of the first wooden piece 118 having an applied layer of glue accelerator (step 324). Prior to performing step 324, the magnets 116 optionally can be covered in grease, silicon, or other coating to enhance slickness. Upon situating the magnets 116, the two wooden pieces 118 can be pressed together using any type of well known positioning fixture (step 326). The wooden pieces 118 can be held together under a predetermined pressure for a predetermined period of time, e.g., under a pressure of about 100 psi for about 15 seconds. One of skill in the art will appreciate that other fastening or bonding methods may be utilized, including but not limited to using aliphatic resin wood glue (at a predetermined pressure and time of 300 PSI and 20 minutes, respectively), or using VHB transfer tape (at a predetermined pressure and time of about 100 PSI and 10 seconds, respectively), or the like.

Via the illustrative method described herein with reference to FIGS. 3A and 3B, the illustrative magnetic toy piece 100 can be produced that is suitable for serving as a building block in conjunction with other such magnetic toy pieces 100. By virtue of the rotatable magnets 116, various toy pieces 100 can be magnetically coupled at any one of three spots along any one of the six faces, thereby enabling a wide variety of attachment configurations. Each of the three magnets 116 in a single toy piece 100 can be spaced at a distance from the other two magnets 116 that is sufficient to enable independent magnetic operation, as described previously herein. Said differently, in the illustrative embodiment, the various magnets 116 embedded within the length 112 of a single wood block component 110 can be configured to not substantially interact with each other in a manner that impacts operation of the magnetic coupling with other magnetic toy pieces 100. Rather, in such illustrative embodiments, magnetic interaction is substantially or entirely dominated by external interactions between magnets 116 contained in abutting or nearby toy pieces 100.

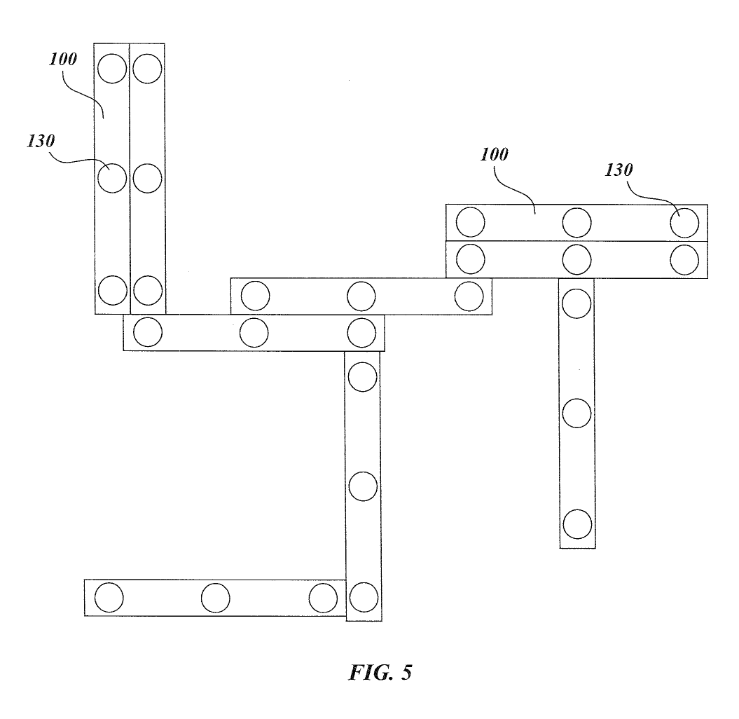

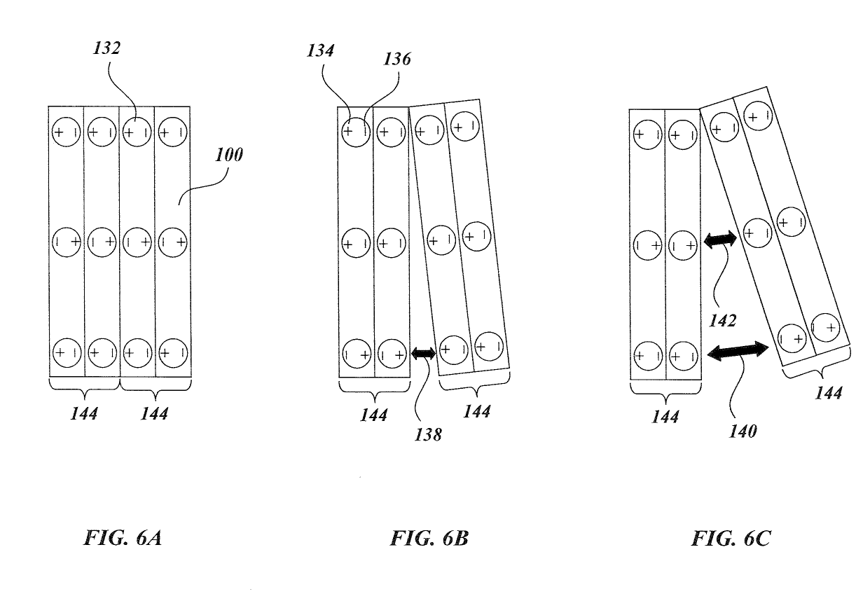

The illustrative magnetic toy pieces 100 are capable of enhanced and more advanced types of attachments. This is due to the fact that both positive magnetic forces of attraction and negative magnetic forces of repulsion are achievable. Such attractive and repulsive forces are demonstrated by the example attachment configurations depicted at least in FIGS. 5 through 6C, and enable advanced attachment configurations that involve pieces 100 attached at angles.

FIG. 5 illustrates an example configuration that includes various types of attachments between a plurality of the magnetic toy pieces 100. The circles 130 indicate the positions of magnets 116 housed within the internal chambers 114. As FIG. 5 demonstrates, any two magnets 116 disposed within different magnetic toy pieces 100 can serve as an attachment point. Furthermore, for any given attachment point, a number of different rotational configurations are possible. While FIG. 5 only shows the magnetic toy pieces 100 attached in a two-dimensional arrangement, one of skill in the art will readily appreciate upon reading the present specification that more complex three-dimensional shapes and configurations are possible. In fact, for two magnetic toy pieces 100 each having three magnets 116, according to illustrative embodiments having housings that are generally shaped as rectangular prisms, there are seventy six unique, possible attachment configurations. When compounded over a set or kit of, for example, forty nine magnetic toy pieces 100, there is a significant number of possible building arrangements.

FIGS. 6A, 6B, and 6C demonstrate the potential interplay of repulsive magnetic forces when attaching multiple toy pieces 100. The effect such of repulsive forces are particularly prevalent when attaching toy dyads 144. “Toy dyads,” as defined herein, are groups of two magnetically connected toy pieces 100. The plus (“+”) signs 134 and minus (“−”) signs 136 indicate magnetic poles (i.e., e.g., “S” and “N”), e.g., the particular orientation of the internal magnet 116 within the toy piece 100, as governed by interaction with additional attached/abutting toy pieces 100. Each of FIGS. 6A, 6B, and 6C illustrates the interaction between two dyads 144 based on different pole orientations of the magnets 116. In FIG. 6A, all of the poles are aligned such that only attractive forces exist. In FIG. 6B, on the other hand, a repulsive force 138 is created by the presence of two adjacent “+” (or “S”) poles at the bottom of the two dyads 144. The pole orientations at the upper and middle attachment points of the two dyads 144, on the other hand, induce attractive forces. Thus, the equilibrium state for such a configuration will include a tilt or angle between the two dyads 144. In FIG. 6C, the tilt or angle between the two dyads 144 is noticeably larger due to the presence of two repulsive forces 140 and 142, caused by the alignment of like poles at the bottom and middle attachment points of the two dyads 144.

In this manner, the range of possibilities is greatly expanded to include angled or tilted types of attachments between multiple toy pieces 100. This provides enhanced stimulation and a wider variety of possible constructions for the user, thereby enabling additional creativity in building such constructions.

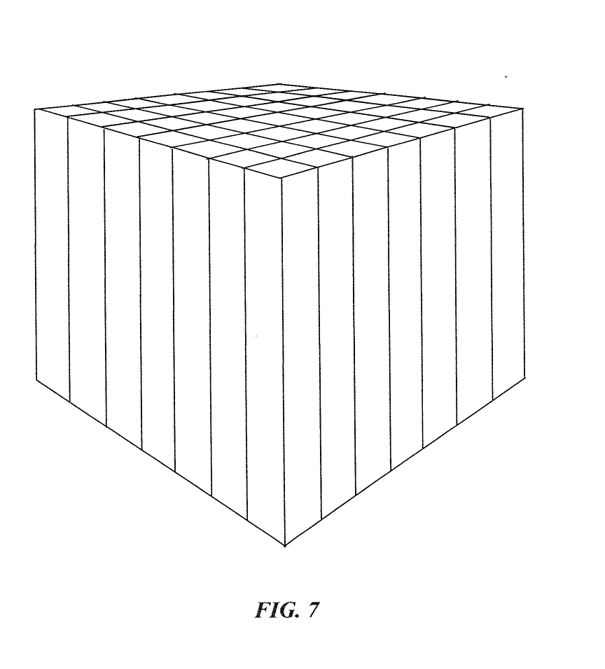

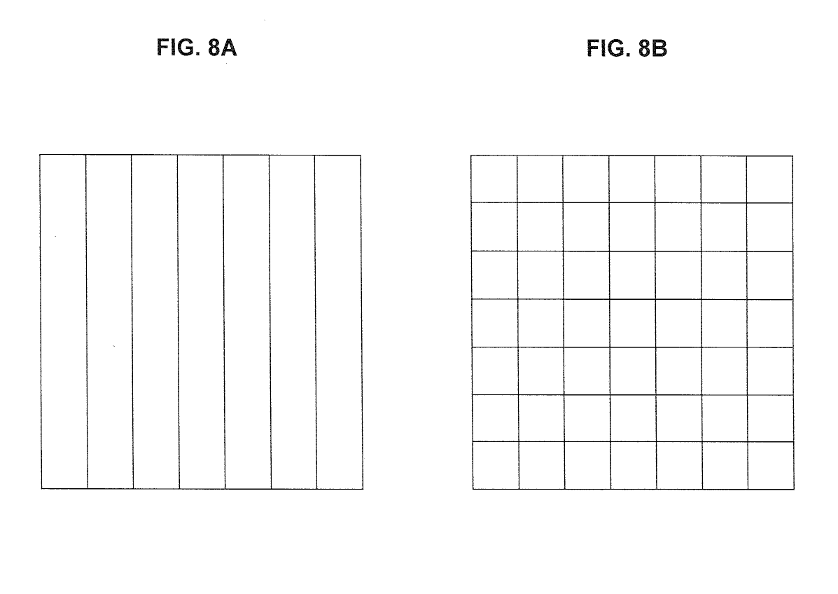

FIG. 7 shows a three-dimensional view of an example kit having a bundled configuration, e.g., for packaging multiple of the illustrative magnetic toy pieces 100 for distribution. For instance, the magnetic toy pieces 100 can be bundled in groups of forty-nine, and arranged in a seven-by-seven polyhedron. In the example configuration of FIG. 7, the spherical magnets 116 can be rotated and aligned such that all adjacent magnets 116 in abutting magnetic toy pieces 100 provide a negative/north (“−” or “N”) pole facing a positive/south (“+” or “S”) pole. This can be useful in minimizing required packaging space, thereby reducing distribution and shipping costs. FIGS. 8A and 8B illustrate side and top views, respectively, of the example kit having a bundled configuration of a plurality of magnetic toy pieces 100, as depicted in FIG. 7. Accordingly, in such a manner as depicted in FIGS. 7 through 8B, bundles of the illustrative toy pieces 100 can be packaged as kits comprising a plurality (e.g., forty nine) of toy pieces 100 arranged, for example, in a seven-by-seven polyhedron.

In addition to the embodiments described herein, many alternative embodiments are possible and contemplated within the scope of the present invention. In particular, more or less than three magnets 116 can be disposed within the wood block component 110. Additionally, the wood block component 110 can have alternative shapes, e.g., which can include one or more surfaces capable of supporting attachment of the magnetic toy piece 100 to additional magnetic toy pieces 100. The surfaces by which toy pieces 100 attach can be flat, as in the illustrative embodiment, or they can have non-flat shapes, such as waves, jags, and other non-planar shapes including some form of protuberance. For example, abutting magnetic toy pieces 100 can be configured to fit together as puzzle pieces. Similarly, the shape of the magnets 116 may vary, and the magnets 116 may have different magnetic pole locations, as would be understood by one of skill in the art. Finally, the magnets 116 need not fit snuggly within the chambers 114 in accordance with certain embodiments. Rather, alternative embodiments of the hollow chambers may include oblong shapes, cylindrical shapes, polyhedron shapes and other shapes that provide a channel through which, or additional space within which, the magnets can move or slide, as determined at least in part on the desired functionality and interoperability of the magnetic toy piece 100. As such, the overall dimensions and configurations can vary based on the particular intended applications.

Furthermore, the wood block component 110 more generally can be any suitable housing formed of one or more walls. For example, the wood block component 110 can include one or more walls forming a hollow block (e.g., made of plastic) having at least one set of substantially opposing (e.g., parallel) faces containing the chambers 114 that house the magnets 116. Other ways to implement the wood block component 110 forming the housing will be readily appreciated by one of skill in the art upon reading the present specification.

As described herein, the present invention provides improved magnetic toy pieces 100 that enable a wide variety of constructions and arrangements. The particular configuration of the magnets 116 enable the magnetic toy pieces 100 to be connected in a stable manner a variety of different angles or tilts. The improved magnetic toy pieces 100 are therefore more desirable to consumers due to these and other improved features, as described in detail herein and readily appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A first toy comprising:
a housing having an elongate shape having a length, the housing comprising two surfaces extending along the length that are substantially opposite one another;
two or more chambers formed within the housing and situated at different positions along the length of the housing; and
two or more permanent magnets each situated within one of the two or more chambers and each being free to assume a plurality of different orientations;
wherein each of the two or more permanent magnets is positioned sufficiently close to each one of the two surfaces to enable magnetic interaction with an adjacent permanent magnet contained in a second toy that is contacting the first toy at that one of the two surfaces of the first toy.

2. The first toy of claim 1, further wherein every permanent magnet contained in the first toy is sufficiently close to each one of the two surfaces to enable interaction with permanent magnets in a second toy that is contacting the second toy at that one of the two surfaces.

3. The first toy of claim 1, further wherein the housing comprises two additional surfaces extending along the length that substantially oppose each other, and further wherein each of the two or more permanent magnets is positioned sufficiently close to each of the two additional surfaces to enable magnetic interaction with permanent magnets in a second toy that is contacting that one of the two additional surfaces of the first toy.

4. The first toy of claim 1, further wherein the magnetic interaction is sufficient to cause each of the two or more permanent magnets in the first toy to assume one of the plurality of different orientations.

5. The first toy of claim 1, further wherein each of the two or more permanent magnets produces a magnetic field that extends beyond each of the two surfaces.

6. The first toy of claim 5, further wherein the magnetic field beyond each of the two surfaces of each of the two or more permanent magnets possesses a strength sufficient to enable interaction with an adjacent permanent magnet in second toy that is contacting the first toy.

7. The first toy of claim 1, wherein each of the two or more permanent magnets are generally spherical in shape, and further wherein each of the two or more chambers are generally spherical in shape.

8. The first toy of claim 1, wherein each of the two or more permanent magnets is a neodiymium magnet.

9. The first toy of claim 1, further comprising an additional chamber contained within the housing and an additional permanent magnet contained within the additional chamber, wherein each of the two or more chambers is located at an end of the length of the housing and the additional chamber is located at a center of the length of the housing.

10. The first toy of claim 1, wherein the housing further comprises a block constructed from walnut wood.

11. The first toy of claim 1, wherein the housing generally has the shape of a rectangular prism.

12. The first toy of claim 1, further comprising:
a third hollow chamber formed within the housing and situated at position along the length of the housing;
a third permanent magnet situated within the third hollow chamber, the third permanent magnet being free to assume a plurality of different rotational orientations within the third hollow chamber;
wherein the third permanent magnet is positioned sufficiently close to each one of the two surfaces to enable magnetic interaction with an adjacent permanent magnet contained in a second toy that is contacting the first toy at that one of the two surfaces of the first toy.

13. A system comprising:
two or more toys, each of the two or more toys comprising:
a housing having an elongate shape having a length, the housing comprising two surfaces extending along the length that are substantially opposite one another;
two or more hollow chambers contained within the housing and situated at different positions along the length of the housing; and
a permanent magnet situated within each of the two or more hollow chambers, such that the permanent magnet is free to rotate in any direction relative to its center point;
wherein the permanent magnet situated within each of the two or more hollow chambers is positioned sufficiently close to each of the two surfaces such that placing the two or more toy pieces in contact at any combination of the two surfaces of each of the two or more toy pieces produces magnetic interaction.

14. The system of claim 13, further wherein any permanent magnet in any one of the two or more toys is sufficiently close to each one of the two surfaces of the any one of the two or more toys to enable interaction with the permanent magnet in at least one of the two or more hollow chambers in the other of the two or more toys when the other of the two or more toys is in contact with the any one of the two or more toys at that one of the two surfaces.

15. The system of claim 13, further wherein, for each one of the two or more toys, the housing comprises two additional surfaces extending along the length that are substantially opposite each other, and further wherein the permanent magnet in each of the two or more chambers is positioned sufficiently close to each of the two additional surfaces to enable magnetic interaction with a permanent magnet in an additional toy that is contacting that one of the two additional surfaces of that one of the two or more toys.

16. The system of claim 13, further wherein, for each of the two or more toys, the magnetic interaction is sufficient to cause the permanent magnet in each of the two or more chambers to assume one of a plurality of different orientations.

17. The system of claim 13, wherein each of the two or more toys comprises an additional chamber contained within the housing and an additional permanent magnet movably contained in the additional chamber, and wherein each of the two or more chambers is located at an end of the length and the additional chamber is located at the center of the length.

18. The system of claim 13, wherein each of the two or more toys further comprises:
a third hollow chamber formed within the housing and situated at position along the length of the housing;
a third permanent magnet situated within the third hollow chamber that is free to assume a plurality of different rotational orientations within the third hollow chamber;
wherein the third permanent magnet is positioned sufficiently close to each one of the two surfaces to enable magnetic interaction with an adjacent permanent magnet contained in an additional toy that is contacting that one of the two surfaces.

19. A method of making a first toy, the method comprising:
forming first cavities into a first block or portion of a housing and forming second cavities into a second block or portion of the housing;
situating a permanent magnet in each of the first cavities formed in the first block or portion of the housing; and
fastening the second block or portion of the housing to the first block or portion of the housing such that the first cavities and the second cavities align to form a first chamber and a second chamber each containing a permanent magnet;
whereby the housing is formed having an elongate shape and a length, the housing comprising two surfaces extending along the length that substantially oppose one another; and
wherein the permanent magnet situated in each of the first chamber and the second chamber is positioned sufficiently close to each one of two surfaces to enable magnetic interaction with an adjacent permanent magnet contained in a second toy contacting that one of the two surfaces of the first toy.

20. A kit comprising:
a plurality of toys, each comprising:
a housing having an elongate shape having a length, the housing comprising at least two surfaces that are substantially parallel one another;
three hollow chambers within the housing and situated at different positions along the length of the housing; and
a permanent magnet situated within each of the three hollow chambers, such that the permanent magnet in each of the three hollow chambers is free to rotate in any direction relative to its center point and thereby assume any one of a plurality of different rotational orientations;
wherein the permanent magnet in each of the three hollow chambers is situated sufficiently close to each one of the two surfaces to enable magnetic interaction with an additional magnet in an additional toy contacting that one of the two surfaces.
